(19) United States
(12) Patent Application Publication
(10) Pub. No.: US 2007/0271197 A1
(43) Pub. Date: Nov. 22, 2007

(54) Investment method

(76) Inventor: Stuart Alexander Law, Stockport (GB)

Correspondence Address: PILLSBURY WINTHROP SHAW PITTMAN LLP, P.O BOX 10500, McLean, VA, 22102, US

(21) Appl. No.: 11/436,867

(22) Filed: May 18, 2006

(51) Int. Cl. G06Q 40/00

(52) U.S. Cl. 705/36 R; 705/38

(57) ABSTRACT

An investment method, comprising; borrowing a first sum of money and investing the first sum of money in a first investment selected to provide a high income. The investment method further comprises investing in a second investment selected to provide high equity growth; selling the second investment to realise equity in the second investment; and using some or all of the equity in the second investment to repay some or all of the first sum of money.

### FIELD OF THE INVENTION

The present invention relates to an investment method. In particular, but not exclusively, the present invention relates to a method of investing in property (for instance, real property) in order to provide income at a future date. More particularly, embodiments of the present invention provide income at a potentially accelerated future date compared to known investment methods.

### BACKGROUND TO THE INVENTION

It is known to make property investments. Property investments can be categorised into two main types. A first type of property investment comprises a high income property investment. An income property investment is a type of property investment selected to provide high income, though possibly at the expense of limited equity growth. For an investment in real property, an income property would be a property investment that is expected to provide high rental income, relative to the cost of borrowing to make that investment, though possibly at the expense of limited growth in value of the property.

A high income property investment may be a leveraged investment. That is, a high income property investment may be made by borrowing money to allow the purchase of the property. For a leveraged high income property investment, the property is selected to generate significantly more income (for example rental income) than the interest repayments associated with a loan or mortgage used to purchase the property. High income property investments are made primarily for their income value. The income is used to repay the loan over time, until the point at which the loan is fully repaid and the property becomes a debt free income generating asset.

A second type of property investment comprises a high equity growth property investment. A high equity growth property investment is a property investment that is expected to generate high equity growth, though possibly at the expense of reduced income. Equity growth may be achieve both through high income used to repay a mortgage associated with the property (thereby reducing the mortgage as a percentage of the current value). Alternatively, or in addition, equity growth can be achieved through an increase in the value of the property. For an investment in real property, a growth property investment is a property that is expected to experience high growth in value of the property, though possibly at the expense of limited rental income now or in the future. A high growth property can be a leveraged investment made primarily for capital growth. Income from a high growth property is typically only intended to service any debt associated with the investment.

There are a number of situations in which it is desirable to make property investments for which the investment is not expected to recoup a net income for a number of years. For instance, in order to provide a retirement income, or independent income prior to retirement, it is known to invest in high income properties. As another example, it is known to invest in income properties to provide a future income for dependants. This may be desirable for inheritance tax planning. To provide a retirement income, property, such as houses, is purchased selecting properties expected to achieve high rental income relative to the cost of borrowing, a mortgage associated with the purchase of the property can be repaid over a number of years. Once the balance of the mortgage has been repaid, the net rental income (after costs associated with running the property investment) then represents investment income for the investor. If a property investor has a desired retirement date then property investments can be selected such that they will have repaid the mortgage associated with the purchase of the property from rental income. At the planned retirement date the net rental income represents pure retirement income. However, high income property on its own can take a long time to repay the balance of a loan or mortgage used to purchase the property, possibly longer than the investor wants to wait before retirement.

An alternative known property investment strategy is to investment in only property that is selected to achieve high equity growth (possibly at the expense of less rental income). However, the disadvantage of this type of property investment is that after the increase in equity has been realised, through selling the property, there is no ongoing income stream and the proceeds of the sale need to be invested in an alternative investment. Furthermore, growth property may fail to deliver the capital growth that the investor is relying upon in order to then purchase an income generating investment in retirement.

It is an object of the present invention to obviate or mitigate one or more of the problems associated with the prior art. In particular, it is an object of the present invention to provide an investment method that potentially produces a net income in a reduced time frame relative to known investment methods.

### SUMMARY OF THE INVENTION

According to a first aspect of the present invention there is provided an investment method, comprising; borrowing a first sum of money; investing the first sum of money in a first investment selected to provide a high income; investing in a second investment selected to provide high equity growth; selling the second investment to realise equity in the second investment; and using some or all of the equity in the second investment to repay some or all of the first sum of money.

An advantage of the present invention is that by utilising a combination of investment types, including high income and high growth investments, an investor is able to balance the strength of an income generating investment with a secondary investment achieving high growth, with the net result that a debt free net income can potentially be achieved earlier than would have otherwise been possible from an investment method utilising only high income property investments. If the growth property can be purchased for a minimal level of additional cost then the income generated per unit of total invested money is not significantly reduced.

The investment method may further comprise: receiving a first income generated from the first investment; and paying interest payments incurred in borrowing the first sum of money from the first income generated from the first investment.

The investment method may further comprise: paying capital payments repaying part of the first sum of money from the first income generated from the first investment.

The investment method may further comprise: borrowing a second sum of money to invest in the second investment.

The investment method may further comprise: receiving a second income generated from the second investment; and paying interest payments incurred in borrowing the second sum of money from the second income generated from the second investment.

The investment method may further comprise: paying capital payments repaying part of the first sum of money from the second income generated from the second investment.

The investment method may further comprise: assessing whether the equity in the second investment exceeds a balance of the first sum of money; and wherein the step of selling the second investment is carried out if but only if the equity in the second investment exceeds a balance of the first sum of money.

The investment method may further comprise: using some or all of the equity in the second investment to repay all of the first sum of money; and using a net first income generated from the first investment after all of the first sum of money is repaid to provide an investment income.

The investment method may further comprise: using some of the equity in the second investment to repay all of the first sum of money; and using a balance of the equity in the second investment to provide a cash lump sum to an investor.

The first investment may be selected to provide a high income relative to repayment costs for repaying part of the first sum of money.

The second investment may be selected to provide high growth in value.

The second investment may be selected to provide a high income relative to repayment costs for repaying part of the second sum of money.

The first investment may comprise an investment in real property.

The step of investing in a first investment may comprise investing in multiple properties selected to provide a high income.

The second investment may comprise an investment in real property.

The step of investing in a second investment may comprise investing in multiple properties selected to provide high equity growth.

The investment method may comprise managing a managed investment fund.

The investment method may further comprise: investing a cash deposit in the first investment.

Said step of borrowing a first sum of money may be preceded by a step of agreeing to borrow the first sum of money.

According to a second aspect of the present invention there is provided a carrier medium carrying computer readable code for controlling a computer to carry out the above method.

According to a third aspect of the present invention there is provided a computer apparatus for making investments, the apparatus comprising: a program memory storing processor readable instructions; and a processor configured to read and execute instructions stored in said program memory; wherein the processor. readable instructions comprise instructions controlling the processor to carry out the method of claim 1.

According to a fourth aspect of the present invention there is provided an investment portfolio management system, adapted to implement the above investment method.

The investment portfolio management system may be further adapted to calculate a break even date in the future at which the equity in the second investment will exceed a balance of the first sum of money.

Said calculation of the break even date may be based upon predicted income generated by the first investment, and a predicted rate at which the first sum of money is to be repaid from the predicted income.

Said calculation of the break even date may be further based upon predicted equity growth in the second investment.

The investment portfolio management system may be further adapted to calculate a predicted investor income after the break even date based upon the predicted income generated by the first investment after the break even date.

### BRIEF DESCRIPTION OF THE FIGURES

The present invention will now be described, by way of example only, with reference to the accompanying drawings, in which:

FIG. 1 is a graph illustrating the reduction of mortgage balance over time and the point at which property investments yield a net income for a known property investment method;

FIG. 2 is a graph illustrating the reduction of mortgage balance over time for a first investment of a first type of investment, the growth in equity for a second investment of a second type of investment, and the point at which the investments yield a net income for a property investment method in accordance with the present invention;

FIG. 3 is schematic illustration of a graphical user interface providing an investment property portfolio summary forming part of an investment property portfolio management tool in accordance with embodiments of the present invention;

FIG. 4 is a schematic illustration of the operation of part of the graphical user interface of FIG. 3;

FIG. 5 is a schematic illustration of a graphical user interface for adding an investment property to an investment property portfolio, forming part of the investment property portfolio management tool in accordance with embodiments of the present invention;

FIG. 6 is a schematic illustration of a graphical user interface for editing details of an investment property in an investment property portfolio, forming part of the investment property portfolio management tool in accordance with embodiments of the present invention;

FIG. 7 is a schematic illustration of a graphical user interface for duplicating an investment property within an investment property portfolio, forming part of the investment property portfolio management tool in accordance with embodiments of the present invention;

FIG. 8 is a schematic illustration of a graphical user interface for entering or amending assumption data, forming part of the investment property portfolio management tool in accordance with embodiments of the present invention; and

FIGS. 9a and 9b together form a schematic illustration of a graphical user interface providing output calculation data to a user, forming part of the investment property portfolio management tool in accordance with embodiments of the present invention.

### DETAILED DESCRIPTION OF EMBODIMENTS OF THE INVENTION

Embodiments of the present invention relate to property investments in both high income properties and high growth properties. A first example of a high income property is commercial property, such as a small office building in the UK that yields net rental income at 7% of the purchase price per annum. If purchased using a mortgage with a 6% interest rate on a 70% loan to value ratio (that is the initial mortgage is 70% of the value of the property) then the interest cost would be 4.2% of the property price per annum leaving 2.8% per annum of the property price as gross profit out of which tax and mortgage capital repayments can be made. In a tax free environment this would repay a mortgage in around 16 years and leave all the net rental income as profit for the investor after that time.

A second example of a high income property is a Bulgarian ski property, such as a small ski apartment, that yields around 10% gross income per annum. Assuming a 20% management charge, this leaves 8% net rental income per annum, as a percentage of the property price. Purchasing on a Euro mortgage at an interest rate of 4% on a 70% loan to value ratio mortgage would have an interest cost of 2.8% of the property price leaving a rental profit of 5.2% per annum of the property price as gross profit out of which tax and mortgage capital repayments can be made. In a tax free environment this would repay a mortgage in around 11 years and leave all the net rental income for the investor after that time.

A first example of a high growth property investment is a UK buy to let investment, for example an apartment purchased with an 85% loan to value mortgage and a 5% deposit subsidy from the developer, leaving the investor to only invest a deposit of 10% of the purchase price. By way of the 5% developer subsidy the investor has potentially already made a 50% return on investment. If property prices rise at just 5% per annum over ten years then a £100,000 property would be worth 63% more than the purchase price. Including the gain from the developer deposit of 5% the investor has turned £10,000 into £78,000, a growth of 680% on the original investment (neglecting the effects of inflation), or a compound growth per annum of 22.8%. In this case the growth investment performs particularly well due to the low deposit and consequentially, the very high level of borrowing.

A second example of a high growth property is a Bulgarian ski apartment. In this case the ski apartment will be regarded as a growth property due to the country seeing both high rental income and high growth concurrently at present. Assuming a mortgage deposit of 30% is required and a compound growth per annum on property prices of 10% the investor would see their 30% deposit grow 6.3 times over ten years, or at a compound growth per annum of 20% per annum. This ignores the additional benefit of the net rental profit on this type of property reducing its debt and hence further increasing the equity growth over time.

As discussed above in the background to the invention, it is known to invest in high income property in order to provide an income at a future date (alternatively referred to herein as a deferred income). High income property is property that is selected to provide a high rental income. The rental income is used to repay a loan or mortgage used to purchase the high income property. The higher the net rental income for the income property, relative to the interest rate for the debt on that property, the quicker the loan or mortgage will be repaid. If the mortgage for a property is repaid sooner then the date at which the property generates a net income for the property owner is brought forward.

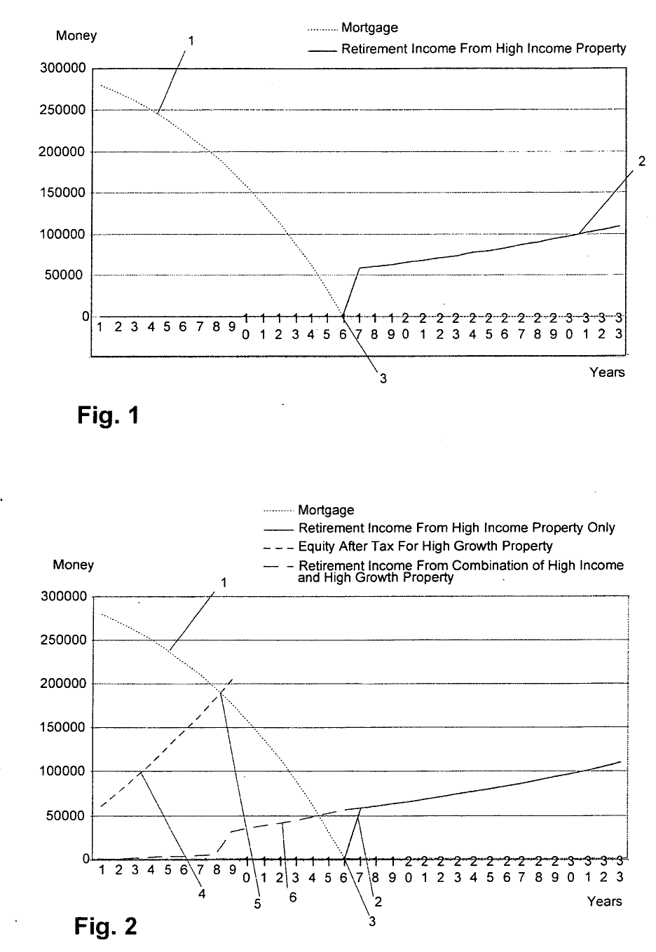

Referring now to FIG. 1, this illustrates in the form of a graph a known property investment method, comprising investing only in high income property. For an investment in high income property (which may comprise a single property or multiple properties) made at the start of year one, the mortgage balance (shown by line 1) and the investor income (such as a retirement income shown by line 2) are plotted against time in years. It can be seen that for the first 16 years there is no retirement income and all of the rental income is used to repay the mortgage. For the first 16 years the mortgage balance represented by line 1 decreases. The decrease is shown as accelerating, as is typically the case due the proportion of mortgage repayments comprising interest reducing over time. At point 3, after 16 years, the mortgage balance reduces to zero. From then on, net rental income becomes entirely investor income, represented by line 2. From year 17 onwards the retirement income is shown rising gradually, as would typically be the case due to the effect of inflation. The effect of rental voids, between tenants is not shown for simplicity.

The present inventor has realised that the point at which a high income property yields a net retirement income can be brought forward by combining investments in high income property with additional investments in high equity growth property. That is, the date at which the high income property delivers a given level of net income (once the mortgage has been paid off) can be brought forward by diversifying the property investment portfolio.

In accordance with certain embodiments of the present invention, alongside investing in high income property, investments are made in property that is expected to secure high equity growth. Equity growth can be achieved through repaying the mortgage associated with the property or an increase in value of the property. At the point at which the accrued equity (after any tax) in the high growth property exceeds the balance of the mortgage associated with the high income property, the high growth property is sold and the equity after tax is used to repay the mortgage associated with the high income property. In certain embodiments of the invention, whether a property is classified as a high income property or a high growth property is flexible, and can be changed, for instance according to how the properties are performing in terms of equity growth and income, relative to one another.

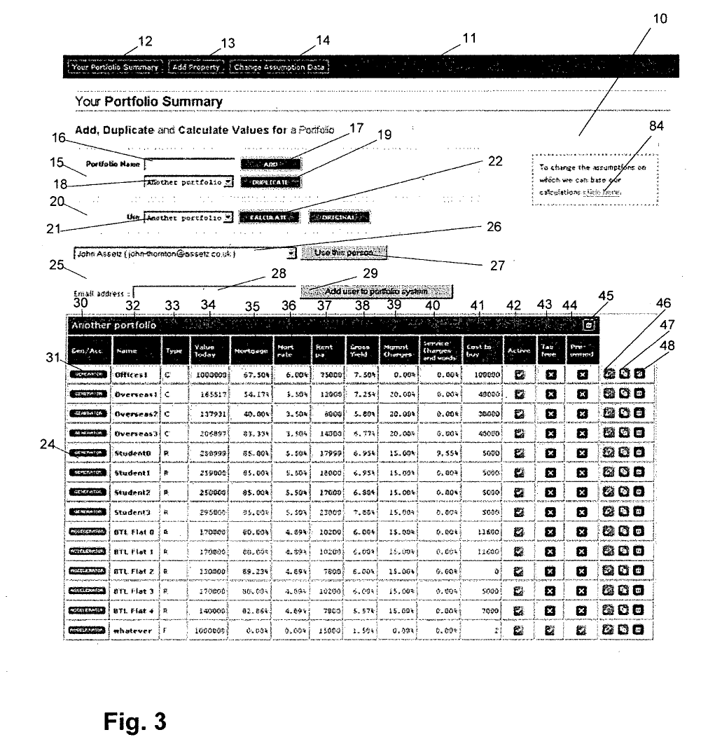

Referring now to FIG. 2, this illustrates in the form of a graph a property investment method in accordance with embodiments of the present invention. As for the known property investment method depicted in FIG. 1, the mortgage balance associated with the high income property is depicted by line 1, and the net investor income, if there was no investment in high growth property is depicted by line 2. If there was no investment in high growth property then the mortgage balance associated with the high income property would still reduce to zero after 16 years at point 3, from which point the rental income from the high income property investment would be the net retirement income depicted line 2.

However, FIG. 2 further illustrates the increase in equity (that is the difference between the market value and the mortgage associated with the property) for a high growth property. The increase in equity is depicted by line 4. The high income property investment and the high equity property investment may typically be made at the same time, although this is not necessarily the case. It can be seen that over a number of years the equity of the high growth property (line 4) increases until after 8 years the equity of the high growth property (after tax) exceeds the mortgage balance for the high income property at point 5. In accordance with embodiments of the present invention, at point 5 the high growth property is sold and the equity after tax is used to pay off the mortgage balance of the high income property. From this point onwards the rental income of the high income property represents net investor income, indicated by line 6.

The rental income represented by line 6 is the same as that represented by line 2. The rental income depicted by both lines 2 and 6 is shown as increasing over time due to inflation. The difference from the graph of FIG. 1 is that due to the additional investment in high growth property, the date at which the property investment method in accordance with embodiments of the present invention provides a net investor income is brought forward by eight years. This clearly represents a substantial improvement over financial investment methods known in the art.

It will be appreciated that the growth of equity in the high growth property is difficult to accurately predict as it relies upon predicting capital growth of property prices which can be unstable over the short and medium term. However, as illustrated by line 2 in FIG. 2, even if the high growth property fails to increase its equity sufficiently fast, the result is that the high income property will, in any event, have repaid its associated mortgage at the latest by year 16, provided that the rental income is consistent over that time period (something that for higher quality property is more predictable than capital growth). The result is that the property investment method of embodiments of the present invention operates at a reduced risk relative to just high income or just high growth property investments. For a little more cost of purchasing, even with very low capital growth, the sale of the growth properties allows an investor to make up for an unexpected reduction in income from the high income properties leading to a slower repayment of the loan on that property. Thus, the investor is still able to achieve a net investor income at the latest by the original date (after 16 years for the example of FIG. 2), i.e. the date at which the high income properties would have delivered a net investor income if there had been no additional investment in high growth properties. As long as the rental income for the high growth property at least matches the interest accrued on the mortgage for the high growth property, then even if there is no increase in equity the date at which the high income property returns a retirement income will be no worse than the point at which it would have returned a retirement income if there had been no investment in high growth property.

High income property investments and high growth property investments are selected according to a number of criteria. Particularly for high income property investments, ideally the investment should not require any involvement from the investor, such as a fully managed investment. This is because as the investment may well be required to provide an income for the investor in their retirement the necessity for work and time from the investor in managing the property is to be avoided.

A high income investment should provide a high income relative to the cost of loan or mortgage repayments. This is calculated by comparing the gross yield of the property (i.e. rental or other income before loan repayments and other associated property costs) to the effective loan repayment rate, (loan to value percentage*interest rate percentage applicable on the loan). Loan to value is the percentage of the property's value that is mortgaged. Income relative to the cost of the loan is the gross profit from the rent after loan interest costs, represented as a percentage of the property price. The larger the income relative to the cost of the loan (gross yield %—(loan to value %*loan interest rate %)) the faster the mortgage capital can be repaid with excess rental profits.

A high income property should be selected such that it is capable of achieving a sufficient rental income in order to be able to repay the loan from its own income within a sufficiently short time frame (e.g. by the latest date at which the investor wants to retire). By being able to repay its own loan within a predetermined time frame, even if the high growth investment(s) fail to achieve high equity growth, the high income properties will still provide a net retirement income within a reasonable time frame, albeit at a later date than if the high growth property had performed as expected.

A high income property should be selected to provide a high annual rental income ratio relative to the initial purchase costs (for instance a deposit on the investment, legal costs etc). This ensures that for a given level of investment, the investor will see a high annual rental income per unit of invested cash.

A high growth property is selected to be highly leveraged, ie to have a high loan to value ratio, and to still have the loan interest serviceable from the net income of the investment. This means that growth property should have enough rental gross yield to cover its annual costs including interest payments. This should be possible on the maximum loan to value ratio permitted by lending institutions for that type of property in order to allow the use of the least capital possible in implementing the investment and still have the loan interest and other costs covered by the income on the property.

Preferably, a high growth property should have at least a breakeven income during the first year. Thereafter, the income should be expected to grow over time. The maximum loan to value possible is important as this maximises the compound growth on cash invested over a period of time compared to just purchasing the investment for cash. In achieving a low deposit (i.e. high loan to value) the investor is helping to achieve the ideal outcome of maximising the deferred annual income from the investment system relative to the original sum of money invested. The most ideal investment would be one that required no up front expense at all and still had sufficient income to cover all annual costs.

Typically, a high growth property is purchased under an interest only loan, due to the fact that it is mainly selected to have high equity growth. This is likely to be at the expense of high rental income, so a high growth property is unlikely to repay its loan at an acceptable rate. Alternatively, high growth property also having high income, may be purchased using a repayment mortgage rather than generate a net rental income after all costs.

For a high growth property, the projected equity growth should be maximised relative to the initial cost to purchase the property. This helps to minimise the ratio of cash invested relative to the annual income once all debt is repaid. Typically, a high growth property should be expected to achieve 20 to 30% per annum growth on net cash invested in retirement planning timeframes of 10 to 20 years.

In accordance with embodiments of the present invention there is provided a managed investment fund (alternatively referred to herein as a deferred income fund) providing managed investment in high income property and high growth property in the manner described above in relation to FIG. 2. Certain embodiments of the present invention relate to a software based investment property portfolio management and planning system for managing such a deferred income fund, or indeed managing individual retirement income plans. The software systems may be implemented via the Internet.

Amongst other functions, the software system implements a number of risk management functions. This information is of great value to a user (e.g. an individual investor or a managed fund manager) of such an investment property portfolio management tool in that the risk management functions can alert the user to changes in the investment environment that would require the user to take action to prevent incurring financial losses, or limit the scale of such losses.

The software system is adapted to calculate the average annual percentage property price fall that would lose all of the equity in the high growth property element of the portfolio. By monitoring the calculated average percentage price fall provided by the software system, and monitoring actual changes in the average prices of property an investor is able to proactively make a decision as to whether to dispose of high growth property before any loss or further loss is incurred.

As discussed below in further detail, the software investment property portfolio management system is adapted to take account of predicted rental voids (that is the predicted duration of each year for which an investment property is empty, and thus not generating income). The system is adapted to calculate the number of weeks of rental void per annum that each property could sustain and still remain cash flow neutral (not operating at a loss) after mortgage interest costs and other property running costs.

The software system is adapted to calculate the level of base interest rate rise applying to variable or tracker mortgages that would cause a property to become cash flow neutral based upon current levels of income and costs for the property.

The software system is able to calculate the effect of inflation upon the future real value of the net rental income. For example if rental growth is greater than average inflation over a period then the real value of the rental income would grow over time, and vice versa if the level of inflation is greater than the growth in the rental income. If the rental growth on a given property is less than the assumed inflation rate per annum then the real value of the rental income will drop over.

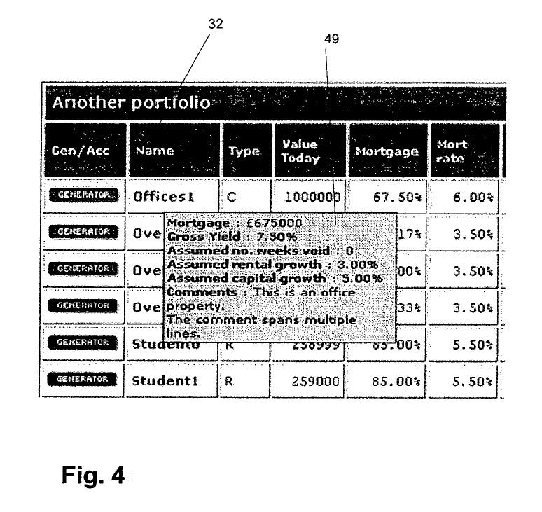

A software system implementing an investment property management system in accordance with embodiments of the present invention will now be described. Referring now to FIG. 3, this schematically illustrates a graphical user interface in accordance with an embodiment of the present invention displaying summary details of a property portfolio managed in accordance with an embodiment of the present invention.

Graphical user interface 10 includes a first display area 11 including three buttons 12-14, which can be manipulated by a user. First display area 11 is generally visible regardless of the state of the graphical user interface. Selecting button 12, labelled “Your Portfolio Summary” has no function in the graphical user interface shown in FIG. 3, as this information is already displayed. Selecting button 12 when the graphical user interface is in other states returns the interface to the portfolio summary shown in FIG. 3. The purpose of buttons 13 and 14 will be described below.

In FIG. 3 a summary of a property portfolio acquired in accordance with an investment method according to an embodiment of the present invention is displayed. Graphical user interface 10 includes a second display area 15, which includes a text box 16 and a button 17 labelled “Add”. By entering a name of a new property portfolio in text box 16 and selecting button 17 a new portfolio can be generated. Alternatively, if required an existing property portfolio can be selected from drop down menu 18 and duplicated by selecting button 19 labelled “Duplicate”.

Graphical user interface 10 included a third display area 20, comprising drop down menu 21 and a button 22 labelled “Calculate”. The function of button 22 will be described below. Selecting the name of an existing property portfolio from drop down menu 21 causes that portfolio to be displayed in a fourth display area 24.

A fifth display area 25 contains a drop down menu 26 and a button 27 labelled “Use this person”. Each property portfolio displayed in drop down menu 21 is associated with a person as selected from drop down menu 26. Selecting a new name from drop down menu 26 and selecting button 27 changes the currently selected system user and thus displays the property portfolios associated with that user in drop down menu 21. A new user can be added to the system by entering that users email address in text box 28 and selecting button 29 labelled “Add user to portfolio system”.

As noted above, the currently selected property portfolio is displayed in display area 24. Display area 24 comprises a table listing each property within the portfolio as a separate line, and information relating to the properties as columns. Whether a property is a high income property or a high growth property is shown as a label in first column 30. For instance, the property shown in the first line 31 is a high income property. In an investment property portfolio management system according to embodiments of the present invention, high income properties are labelled “Generator” properties and high growth properties are labelled “Accelerator” properties.

The column labelled “Name” (32) displays a short informal name chosen by the user for that property. The column labelled “Type” (33) shows for each property either a “C”, “R”, “O” or “F” according to whether a given property is a commercial property, a residential property, and overseas property or an investment fund respectively.

The column labelled “Value today” (34) displays for each property the current estimated value of the property. The column labelled “Mortgage” (35) displays for each property the current mortgage for that property as a percentage of the current value of the property. That is column 35 displays the current loan to value ratio of each property. The column labelled “Mortgage Rate” (36) displays for each property the mortgage percentage interest rate for that property. The column labelled “Rent pa” (37) displays for each property the gross rental income per year. The column labelled “Gross yield” (38) displays for each property the gross rental income as a percentage of the property value today. The column labelled “Mgmnt Charges” (39) displays for each property the management charge as a percentage of the gross rental income. This is usually higher for overseas properties and hands off investments.

The column labelled “Service charges and voids” (40) displays for each property the service charges and the cost of the property being empty for an assumed proportion of the year as a percentage of the gross rental income. The column labelled “Cost to buy” (41) displays for each property either the amount a property cost to buy (in the case of a property already part of that portfolio) or the current cost to buy (which is equal to the figure given in the value today column 34 in the case of a property not yet purchased by the investor).

The column labelled “Active” (42) determines for each property whether it is currently included in the calculations (described below). For each property there is either a tick, if the property is included in the calculations, or a cross if the property is not included in the calculations. Whether a property is a tax free investment is determined by a tick or a cross for that line in column 23. Whether or not an investor already owns a property is determined by a tick or a cross in column 44.

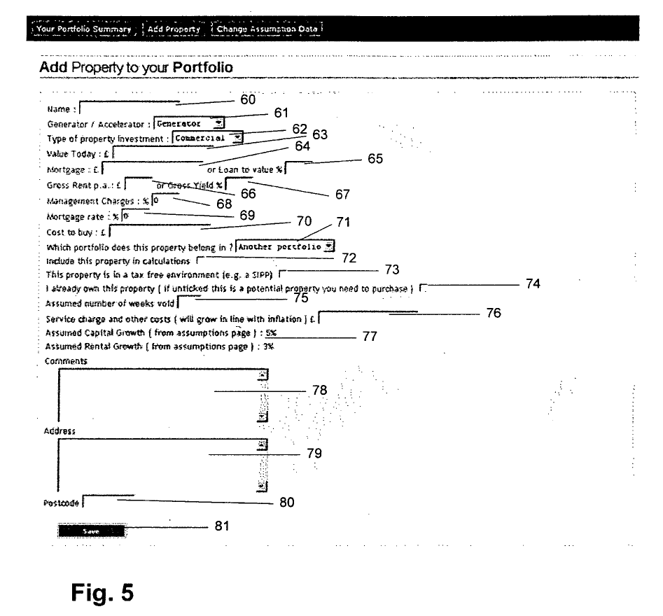

Button 45 if selected by the user deletes the whole of the contents of the currently displayed property portfolio. For each property, a button 46 allows the user to edit the details of the property, a button 47 allows the user to duplicate the property (i.e. use the property details as a template should they purchase or consider purchasing a similar property) and a button 48 allows a user to delete that property from the portfolio. Referring now to FIG. 4, if a user holds the mouse over a property in column 32, details about the property are displayed as a tool tip 49.

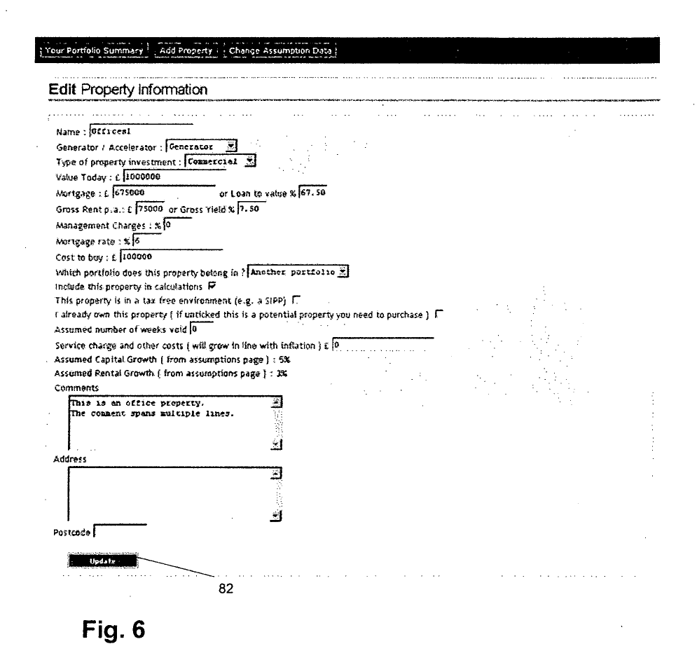

Referring back to FIG. 3, button 13 labelled “Add property” allows a user to add a property to the currently displayed property portfolio, or to any other property portfolio associated with that user. Selecting button 13 changes the graphical user interface to display an interface for entering details associated with a new property, as depicted in FIG. 5.

FIG. 5 displays a number of text entry boxes allowing a user to manually enter information relating to a new property to be added. Box 60 allows a user to assign a name to the new property. Drop down menu 61 allows a user to select whether the new property is a generator or an accelerator property (that is, whether the property is a high income property or a high growth property). Drop down menu 63 allows a user to select what category of the property the new property falls under (commercial, residential, overseas or fund).

Box 63 allows the user to enter the current value of the property. Boxes 64 and 65 allow the user to respectively enter either the size of the mortgage or the loan to value ratio (as a percentage) for the property. Boxes 66 and 67 allow the user to respectively enter either the gross rent or the gross yield (as a percentage of the current value of the property).

Boxes 68 to 70 allow the user to respectively enter the percentage management charges associated with the property, the mortgage interest rate and the cost to buy the property. Drop down menu 71 allows the user to allocate the new property to any of the property portfolios associated with the currently selected investor.

Selection boxes 72 and 73 allow the user to designate whether or not the new property is included in the calculations (described below) and whether or not the property is a tax free investment. Selection box 74 allows the user to designate whether they already own the property, or whether it is a prospective purchase. Box 76 allows the user to enter the service charge and other costs associated with the property (as a percentage of gross rental income).

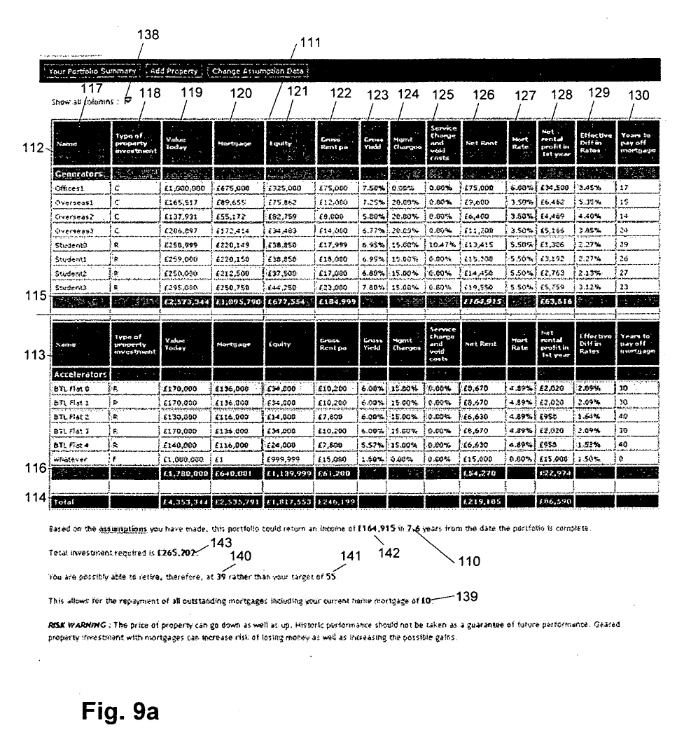

Area 77 of the interface displays the assumed capital growth rate and the assumed rental growth rate per annum. This information is entered by the user via the assumptions graphical user interface, described below in relation to FIG. 8 Boxes 78 to 80 allow the user to enter comments and address details associated with the new property.

Button 81 labelled “Save” allows the user to save the new property details, such that it appears in the graphical user interface shown in FIG. 3 for the property portfolio selected in drop down menu 71.

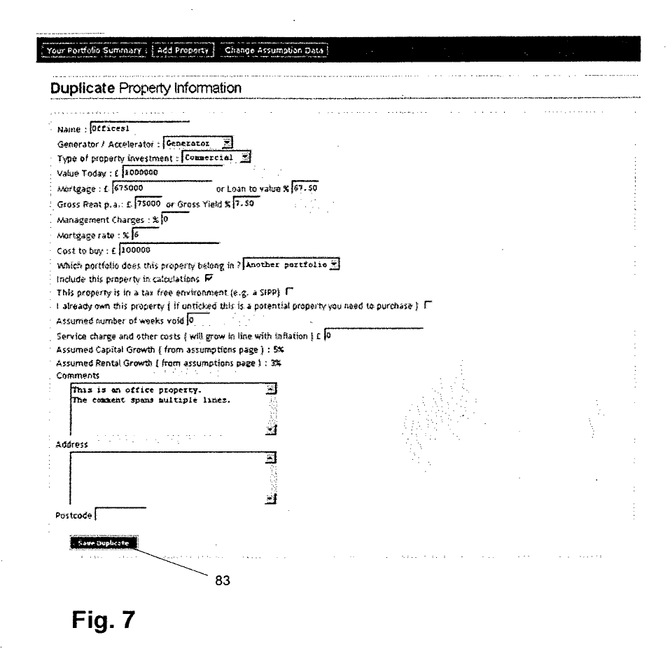

As noted above in connection with FIG. 3, for each property displayed in the currently displayed property portfolio, an “Edit” button 46 can be selected by the user. Selecting button 46 displays a graphical user interface as shown in FIG. 6. The graphical user interface shown in FIG. 6 allows the user to edit the information associated with the property for that button 46. The fields that can be edited by the user are the same as those fields that can be edited for a new property, as shown in FIG. 5. Once the property details have been edited, selecting button 82 labelled “Update” saves the changes to that property.

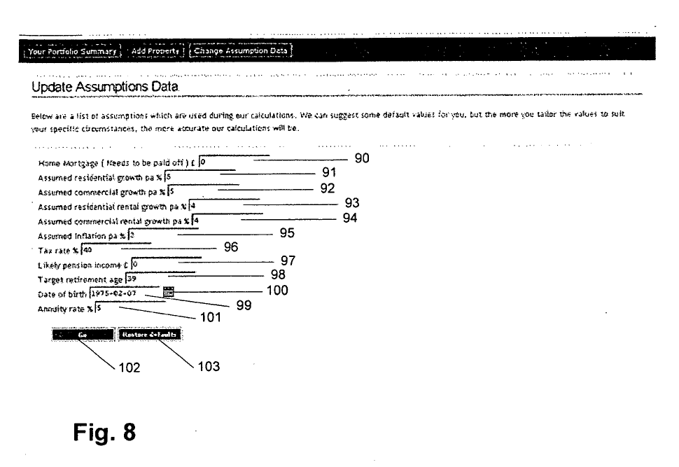

As noted above in connection with FIG. 3, for each property displayed in the currently displayed property portfolio, a “Duplicate” button 47 can be selected by the user. Selecting button 46 displays a graphical user interface as shown in FIG. 7. The graphical user interface shown in FIG. 6 allows the user to duplicate the information associated with the property for that button 47. This can be advantageous as an alternative to adding a new property to a portfolio as discussed above in connection with FIG. 5, when the user is required to add a new property that is similar to a property already forming part of a portfolio. The fields that can be edited by the user are the same as those fields that can be edited for a new property, as shown in FIG. 5. Once the property details have been edited for the duplicated property, selecting button 83 labelled “Save duplicate” saves the changes to the duplicated property.

Referring back to FIG. 3, it will be recalled that button 14 presented the option to the user to change assumption data. Selecting button 14, or alternatively selecting hyperlink 84, presents a graphical user interface as shown in FIG. 8 allowing a user to amend certain data which has a bearing upon calculations carried out by the portfolio planning tool in accordance with embodiments of the present invention.

Referring to FIG. 8, this presents the user with a number of text boxes to enter information which is used throughout all portfolios associated with that user in order to make investment decisions. Box 90 allows the user to enter the amount of their home mortgage, that needs to be paid off from equity growth in high growth investments by a projected retirement date.

Boxes 91 and 92 allow the user to enter the projected future growth in value per annum of residential and commercial property investments respectively.

The assumed rate of price growth for a given high growth property will determine the rate at which equity in the property will grow, subject to other factors. Generally the higher the rate of price growth for a given property the greater the equity growth will be and the sooner the growth property can be sold to repay the balance of mortgages remaining on the income properties.

Boxes 93 and 94 allow the user to enter the projected future growth of rental income per annum for residential and commercial property investments respectively. Boxes 95 and 96 allow the user to enter the projected future inflation rate per annum and their personal tax band respectively.

Box 97 allows the user to enter their minimum desired retirement income. Box 98 allows the user to enter the age at which, at the latest, they wish to retire. Box 99 allows a user to enter their date of birth, or alternatively button 100 displays a calendar interface allowing a user to manually select their date of birth.

Box 101 allows the user to enter the annuity rate. In certain embodiments of the invention, optionally, a user may enter an assumed annuity rate that would apply on a single life annuity policy for that investor at their chosen target retirement date. Such embodiments of the present invention are adapted to indicate to the user what would happen if part or all of the investment property portfolio was sold at the retirement date and invested into a single life annuity policy chosen to pay an indexed income from that point until death.

Selecting button 102 labelled “Go” allows the user to save the changes to the assumption data, and allows this data to be used in the calculations, as described below. Alternatively, selecting button 103 labelled “Restore default” allows the user to undo any changes they have made to the system's default assumption data.

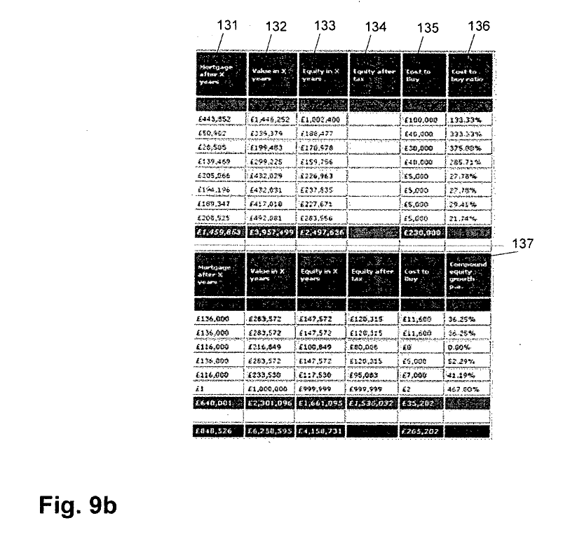

As noted above, the graphical user interface displayed in FIG. 3 includes button 22 labelled “Calculate”. Selecting button 22, in certain embodiments of the present invention, calculates the date at which the equity in high growth properties will exceed the balance of mortgages associated with the high income properties. Selecting button 22 also displays a graphical user interface as shown in FIGS. 9a and 9b. FIGS. 9a and 9b together illustrate a single graphical user interface split into two halves for convenience, and in order to clearly illustrate the detail of the graphical user interface. It will be appreciated that in reality the table shown in FIG. 9b would appear to the user simply a continuation of the table forming part of FIG. 9a.

The graphical user interface of FIGS. 9a and 9b displays the results of a series of calculations performed on the currently displayed property portfolio in accordance with embodiments of the present invention (as will be described in greater detail below), using the assumption data entered by the user in the interface of FIG. 8 (or default data) in order to calculate, amongst other parameters, projected future investor income once the high income properties are debt free, the total required investment and the projected earliest potential retirement date.

The graphical user interface of FIGS. 9a and 9b displays, in the form of a table, information relating to how the currently selected investment property portfolio is predicted to be performing at a given date after the portfolio is completed. The time after the completion date of the portfolio at which the calculations are based is shown (110), and corresponds to the break even date (the date at which the high growth equity equals or exceeds the mortgage(s) for the high income properties). In this case, the break even date is calculated to be 7.6 years from the completion date of the portfolio. Columns in the table relating, for instance, to the value of the property in X years, relate in the example of FIGS. 9a and 9b to the value of the property 7.6 years after the completion date of the portfolio (i.e. the value of the property at the break even date).

Table 111 listing the investment properties is split into two parts 112, 113 relating respectively to the high income properties and the high growth properties (labelled as “Generators” and “Accelerators” respectively). There is also a separate section of the table (114) providing totals for certain columns of the table, and lines 115, 116 for each part of the table providing subtotals for certain columns of the table for the high income properties and the high growth properties respectively.

The columns labelled “Name” (117) gives the user assigned name for each property. Unless otherwise stated, the table columns relate to both high income properties and high growth properties. Column “Type of property investment” 118 labels each property investment as Commercial C, Residential R, Overseas O or a Fund F. “Value today” 119, gives the current market value of the property. “Mortgage” 120 gives the current mortgage value of the property. “Equity” 121 gives the current equity of the property (the value today, minus the current mortgage value). Column “Gross rent pa” 122 gives the current gross rent per year for each property. “Gross yield” 123 gives the current gross rent per year as a percentage of the current market value of the property. “Mgmt charges” 124 gives the management charge associated with that property as a percentage of the gross rent per year. “Service charge and void costs” 125 gives the service charge and the cost of any predicted rental voids as a percentage of the gross rent per year. “Net rent” 126 is the rental income after allowing for management charges, service charge and the cost of rental voids, for each property.

“Mort rate” 127 is the mortgage rate associated with the mortgage for each property. “Net rental profit in 1^{st} year” 128 is the net rental income after allowing for management charges, service charges, the cost of rental voids mortgage, repayments for each property and taxation at the investors marginal rate.

A further figure of merit calculated by the software system is the gross yield gap. The gross yield gap is the gross yield expressed as a percentage of the current value of the property (column 123) minus the product of the loan to value (current mortgage as a percentage of current value—column 120 as a percentage of column 119) and the mortgage interest rate percentage (column 127). Generally speaking, it is important that the gross yield gap is at least 2% for a high income property.

From the net yield gap, a further figure of merit—the net yield gap after all costs can be calculated. The net yield gap after all costs is the gross yield gap (as calculated in the preceding paragraph) minus management charges (column 124) and minus service charges and rental voids (column 125). The net yield after costs needs to be greater than zero for high income properties and preferably at least equal to zero for high growth properties to be break even in the first year.

The net yield gap after all costs, minus taxation at the investor's marginal rate, leaves a true net profit from the rental income. The true net profit is shown in column 128. If this figure is deducted from the loan balance on the property at the end of each year eventually the loan reduces to zero. In alternative embodiments of the present invention the investor is able to withdraw some or all of the true net profit, at the expense of reducing the rate at which the high growth properties pay off their own mortgage and thus extending the period of time until the break even point.

“Effective diff in rates” (129) is the effective difference between the gross yield (as a percentage of the current property value—column 123) and the product of the loan to value (mortgage as a percentage of current value) and the mortgage interest rate (column 127). This calculation gives a measure of the difference between the gross rental profit of the property and the cost of borrowing money to invest in the property. The effective difference in rates (as a percentage of the property current value) is indicative of the amount of money available to the investor to repay a proportion of mortgage balance each year (ignoring for the present purposes the other costs of owning the investment such as management charges).

The time to pay off the mortgage for a property displayed in column 130 is the calculated number of years that this process takes, given the estimated net rental income (after costs and tax) and the prevailing mortgage rate, as will be described in greater detail below. For the high income properties it is important that in an ideal situation no property has a greater number of repayment years than the longest time someone is prepared to wait for income (maximum acceptable retirement age entered in box 98 minus current age entered in box 99 of FIG. 8). This is important because in the event that the high growth property in fact grows at 0% per annum, then the high income property will only become debt free and generator net investor income once it has paid off its own mortgage from net income.

“Mortgage after X years” 131 gives the predicted mortgage balance after X years (that is at the date given at 110). “Value in X years” 132 gives the predicted value of the property after X years. “Equity in X years” 133 gives the predicted equity in the property after X years (that is, the difference between columns 131 and 132). “Equity after tax” 135 gives the predicted net equity after tax for each property after X years. This is important in the context of high growth properties in order to determine the point at which the predicted net equity after tax exceeds the mortgage balance for the high income properties as discussed above. “Cost to buy” 135 gives the cost to buy each property (that is, the amount the investor invested in each property including deposit and other costs such as legal costs).

“Cost to buy ratio” 136 is calculated for high income properties and is equal to the total purchase costs divided by gross rental income per annum for the property. The lower the ratio of purchase costs to rental income per annum, the less the investor is effectively paying for the income stream, although this has to be balanced against how profitable the rental income stream is by looking at the net yield gap after all costs calculation.

“Compound equity growth p.a.” 137 is calculated for high growth properties and gives the calculated compounds growth in equity per year from the present date to year X. This is the compound rate of growth implied from the net cash cost of purchasing the investment (including deposit and all of the purchase costs) and its growth until the calculated retirement date. For example a £5,000 cost to purchase property (column 135) that grew into an after-tax equity of £50,000 over 10 years (column 134) would have a calculated growth in Equity per annum of 25.89% compound growth per annum. If the growth in equity per annum is significantly less than 20% it is likely that the high growth property will not have a significant enough effect over a shorter timescale of for example 10 years and either the planned investment should be increased to, for instance, 20 years or greater or an alternative high growth property selected.

A further figure of merit for high growth properties is the ratio of purchase costs to purchase price. This is the total purchase costs of a property, including deposit and legal expenses, divided by the purchase price of property. The lower the purchase cost compared to the purchase price the greater the potential benefit to the investor of any price growth in the property as a percentage return on their original equity, as calculated above and displayed in column 137.

The graphical user interface illustrated in FIGS. 9a and 9b further includes selection box 138 labelled “Show all columns”. By selecting selection box 138 the user can switch between displaying all of the columns (as illustrated) or displaying a reduced number of columns of table 111.

The graphical user interface of FIGS. 9a and 9b is interactive, in that in response to user input the system is adapted to sort and rank properties according to, for instance, growth potential, income potential, speed of mortgage repayment potential, efficiency of capital investment, rental income and other criteria. The user by initiates this sorting and ranking process by, for instance, selecting the heading of a column. The system is then adapted to reorder the table to display the property portfolio in rank order for the criteria selected by the user.

Having described the structure of the software system, its operation will now be described. The system is designed to calculate from the details of the property investments and the assumptions data entered in the interface of FIG. 8 the date at which equity in the high growth properties is expected to equal the balance of mortgages or other loans associated with the high income properties. Typically, investors will also have a mortgage associated with their own home. The investor is able to enter the current amount of their mortgage in box 90 of FIG. 8. The system is then adapted to include the predicted future value of the home mortgage in the balance of mortgages associated with the high income properties in calculating the date at which the high growth property equity equals the amount to be repaid. FIG. 9a further shows the current amount of the home mortgage, if any, 139.

The investment property portfolio management system calculates the date at which the accrued equity equals the outstanding debt associated with the high income properties by extrapolating forward from the current parameters of the property portfolio, as shown in FIG. 3. The system calculates at periodic intervals, for instance tenths of a year, the predicted future mortgage balance and the predicted future equity in the high growth properties until it reaches a break even point. The system then calculates the length of time until the break even point and displays this information at 110. Furthermore, the system calculates the age of the investor at the predicted break even point and displays this 140 relative to the latest date at which the investor wished to retire 141 (entered by the system user in box 99 in FIG. 8).

At the break even point, some or all of the equity (after tax) accrued in the high growth property is realised by selling some or all of the high growth property. This equity is used to pay off the mortgage balance associated with the high income properties. Alternatively, at the discretion of the investor, some or all of the high growth property may be sold before or after the break even point. Once the high income properties are debt free, the net rental income from the high income properties (after management charges, service charges, the cost of rental voids and tax) represents the investor income. This predicted investor income is displayed to the user (142). The total cost to buy the property portfolio is shown at 143, and is equal to the total for column 135 displayed in portion 114 of table 111.

In order to further illustrate the operation of a investment property portfolio management system in accordance with embodiments of the present invention, the example of using the system for retirement income planning will be used.

An investor, or other user of the system such as a managed fund manager, begins by entering the current details of their property portfolio using the interfaces described in relation to FIGS. 3 to 7, including details of property in which they intend to invest. The user can then optionally continue with system default assumption data, or they can alter the assumption data using the interface of FIG. 8, in order to reflect their personal circumstances.

Selection of the “Calculate” button 22, in a first embodiment of the present invention then causes the management system to calculate the investors earliest potential retirement age. The earliest potential retirement date is calculated as follows: the system calculates the income generated from the high income property (known as generators) for the first year and calculates the net yield gap after all costs, as defined above. After deduction of any tax according to the assumptions the user has made via the interface of FIG. 8, the remaining profit is used to repay part of each mortgage associated with the high income properties. The system moves on to year two with a reduced mortgage balance outstanding on each high income property.

At the same time as calculating the future reduction in mortgage balance for the high income properties, the system calculates the future inflation in rental income year by year for each iteration of the calculation, according to the rental inflation assumptions stored in the data relating to each high income property.

The system further calculates the increase in the property value of the high growth (accelerator) properties. In the first embodiment of the present invention, the system assumes all growth properties are on interest only mortgages (that is, there is no capital repayment). The growth in property price according to the assumptions entered cause the equity in the high growth properties to grow. The system calculates, after relevant taxes, what the equity after tax would be in each high growth property and hence the rise in equity in the high growth property portfolio, (assuming that the property had been sold at the end of each iteration of the calculation).

If an investor's home mortgage defined in the assumptions (FIG. 8) is zero then at some point in the iterated calculations the equity after tax in the growth portfolio (assuming the properties are sold at that point) becomes equal to the reduced balance of the mortgages on the high income portfolio. The calculated timeframe in that this happens is the calculated time until early retirement and is calculated from the present date.

It is assumed that all data entered into the system is up-to-date at the date at which the calculations are made in order for the calculated retirement date to be correct. If the investor has a home mortgage that they wish to repay at the point of retirement then the calculation system takes the home mortgage value from the assumptions entered by the investor and continues the iterations of calculations until the equity after tax on disposal of the high growth investment properties is enough to repay both the home mortgage and the balance of the growth property mortgages at that time.

In certain other embodiments of the present invention, various additional features and options for the investment property portfolio management system may be added.

In certain embodiments, the post tax rental profits from the high income investments could be preferentially be assigned to repaying the most expensive mortgage (i.e. the mortgage with the highest interest rate) to improve the efficiency of repaying the total mortgage value of the high income portfolio.

In certain embodiments, some or all of the rental profits from the high income investments could be paid out to the investor annually, rather than repaying the mortgages. Assuming sufficient growth in equity for the high growth properties, the growth properties would still eventually accrue enough equity to repay the mortgages on the high income properties property, albeit on a longer timeframe. This may be advantageous in order to provide a growing income from the first year for the investor.

In certain embodiments, over time, rental inflation for the growth properties may cause them to become cash generative (that is, exceeding the amount of loan repayments for the high growth properties). This additional income could be used to assist the repayment of the mortgages on either the growth properties and/or the income properties. Alternatively, this additional income could be used to provide a small income for the investor immediately, growing over time, before the point at which the growth properties can repay the income property mortgages.

In certain embodiments, rather than utilising the exact net of tax rental profit from the income properties to repay their mortgages year by year mortgage repayments could be done month by month. The system could be configured to base its predicted future calculations for each property on the basis of each property being repaid on a fixed repayment mortgage. This could cause the rental income in the early years for example to be insufficient for the repayment mortgage cost per annum. In the later years the rental income may be greater than required. In certain embodiments, the system calculates the cash contribution required from the investor in the early years versus the cash generation for the investor in the later years by use of a fixed annual repayment mortgage amount.

In certain embodiments, the system allows high growth properties to be placed on repayment mortgage assumptions. This increases the growth in equity on the income property faster than the price increases alone. If this option is used, then the growth properties are likely to not generate a growing income over time through rental inflation as the entire net profit would be used for repayments on the income properties.

In certain embodiments, the system displays charts of net cash flow generated by the investment portfolio. These charts maybe interactive and dynamic to show the effect of varying the assumptions made by the user. For example, the effects of all interest rates in the system rising by 1%, the effect of all price growth assumptions being reduced or increased by say 1% and/or the effect of all rental growth assumptions being greater or less by say 1% may be modelled and displayed to the user as a graph.

In certain embodiments, the system calculates the extra time required to delay the retirement date in order to generate a specific cash lump sum on retirement. If this option is used, the inflation assumption calculates this cash lump sum in real terms rather than nominal terms.

In certain embodiments, the system is able to calculate the effect of inflation upon the rental income in such a way that the net rental income at the point of retirement is expressed in real terms rather than in nominal terms.

In certain embodiments, the system integrates with mortgage databases in order to suggest to the investor optimal re-mortgaging opportunities available in the marketplace and transmits such requirements for firm quotation provision by mortgage brokers and providers.

In certain embodiments, the system suggests to the user re-mortgaging opportunities if the rental income is sufficient to support a greater loan to value ratio on the lending.

In certain embodiments, the system integrates with online databases of properties for sale in order to give comparable data using the postcode information stored on each property in the system and linking to online databases utilising this postcode.

In certain embodiments, the system could utilise online annuity databases to advise upon the likely income generation potential if some or all of the property portfolio were to be disposed of.

In certain embodiments, the system grades and sorts all the properties by comparing key attributes for other properties in other peoples portfolios, or grades the average performance of other peoples portfolios.

In certain embodiments, the system is able to store future property investment requirements as well as actual investments to date. By storing future property requirements and integrating with property vendors, the system is able to suggest to the user suitable property investments to fulfil the known requirements.

Although the above-described embodiments of the invention are primarily described in relation to investments in real property, the invention is not limited to this. From the above description it will be readily apparent to the appropriately skilled person that the present invention may encompass other types of property investment, and investment in other assets beyond real property. For example an investor may invest in a high growth mutual fund or a private equity investment in order to achieve the high rate of growth per annum required by the growth element of the investment system described. Equally an investor may purchase high yielding ‘junk’ bonds using leverage and repay this debt using the income. Real property however is considered to be one of the most suitable income generating investment types for this system as it often has a high yield compared to cost of debt and often has debt available compared to other classes of asset where such debt is unavailable.

The present invention has been described above in the context of retirement planning, although it will be readily appreciated that this scenario is simply exemplary. Other potential applications of the present invention include inheritance tax planning.

Other modifications and applications of the present invention will be readily apparent to the appropriately skilled person, without departing from the spirit or scope of the appended claims.

1. An investment method, comprising;
borrowing a first sum of money;
investing the first sum of money in a first investment selected to provide a high income;
investing in a second investment selected to provide high equity growth;
selling the second investment to realise equity in the second investment; and
using some or all of the equity in the second investment to repay some or all of the first sum of money.

2. An investment method according to claim 1, further comprising:
receiving a first income generated from the first investment; and
paying interest payments incurred in borrowing the first sum of money from the first income generated from the first investment.

3. An investment method according to claim 2, further comprising:
paying capital payments repaying part of the first sum of money from the first income generated from the first investment.

4. An investment method according to claim 1, further comprising:
borrowing a second sum of money to invest in the second investment.

5. An investment method according to claim 4, further comprising:
receiving a second income generated from the second investment; and
paying interest payments incurred in borrowing the second sum of money from the second income generated from the second investment.

6. An investment method according to claim 5, further comprising:
paying capital payments repaying part of the first sum of money from the second income generated from the second investment.

7. An investment method according to claim 1, further comprising:
assessing whether the equity in the second investment exceeds a balance of the first sum of money; and
wherein the step of selling the second investment is carried out if but only if the equity in the second investment exceeds a balance of the first sum of money.

8. An investment method according to claim 7, further comprising:
using some or all of the equity in the second investment to repay all of the first sum of money; and
using a net first income generated from the first investment after all of the first sum of money is repaid to provide an investment income.

9. An investment method according to claim 7, further comprising:
using some of the equity in the second investment to repay all of the first sum of money; and
using a balance of the equity in the second investment to provide a cash lump sum to an investor.

10. An investment method according to claim 1, wherein the first investment is selected to provide a high income relative to repayment costs for repaying part of the first sum of money.

11. An investment method according to claim 1, wherein the second investment is selected to provide high growth in value.

12. An investment method according to claim 4, wherein the second investment is selected to provide a high income relative to repayment costs for repaying part of the second sum of money.

13. An investment method according to claim 1, wherein the first investment comprises an investment in real property.

14. An investment method according to claim 13, wherein the step of investing in a first investment comprises investing in multiple properties selected to provide a high income.

15. An investment method according to claim 1, wherein the second investment comprises an investment in real property.

16. An investment method according to claim 15, wherein the step of investing in a second investment comprises investing in multiple properties selected to provide high equity growth.

17. An investment method according to claim 1, wherein the investment method comprises managing a managed investment fund.

18. An investment method according to claim 1, further comprising:
investing a cash deposit in the first investment.

19. An investment method according to claim 1, wherein said step of borrowing a first sum of money is preceded by a step of agreeing to borrow the first sum of money.

20. A carrier medium carrying computer readable code for controlling a computer to carry out the method of claim 1.

21. A computer apparatus for making investments, the apparatus comprising:
a program memory storing processor readable instructions; and
a processor configured to read and execute instructions stored in said program memory;
wherein the processor readable instructions comprise instructions controlling the processor to carry out the method of claim 1.

22. An investment portfolio management system, adapted to implement the investment method of claim 1.

23. An investment portfolio management system according to claim 22, further adapted to calculate a break even date in the future at which the equity in the second investment will exceed a balance of the first sum of money.

24. An investment portfolio management system according to claim 22, wherein said calculation of the break even date is based upon predicted income generated by the first investment, and a predicted rate at which the first sum of money is to be repaid from the predicted income.

25. An investment portfolio management system according to claim 24, wherein said calculation of the break even date is further based upon predicted equity growth in the second investment.

26. An investment portfolio management system according to claim 24, further adapted to calculate a predicted investor income after the break even date based upon the predicted income generated by the first investment after the break even date.
